(19) United States
(12) Patent Application Publication
(10) Pub. No.: US 2016/0138423 A1
(43) Pub. Date: May 19, 2016

(54) TITANIUM-ALUMINIDE COMPONENTS

(71) Applicant: Rolls-Royce North American Technologies, Inc., Indianapolis, IN (US)

(72) Inventors: Nathan W. Ottow, Indianapolis, IN (US); Robert A. Ress, Carmel, IN (US)

(21) Appl. No.: 14/212,061

(22) Filed: Mar. 14, 2014

Related U.S. Application Data
(60) Provisional application No. 61/801,093, filed on Mar. 15, 2013.

(51) Int. Cl. F01D 25/24; B22F 1/00; B32B 3/30; B22F 7/04; B22F 3/15; B32B 15/01; C22C 14/00; B22F 5/00

(52) U.S. Cl. CPC F01D 25/24; C22C 14/00; B22F 1/0003; B22F 5/009; B22F 7/04; B22F 3/15; B32B 15/017; B32B 3/30; B22F 2007/042; B22F 2301/205; F05D 2220/32; F05D 2230/31; F05D 2230/10; F05D 2230/90; F05D 2300/174; B32B 2605/18

(57) ABSTRACT

The present disclosure relates to a hot section gas turbine engine component assembly and a method for forming such.

### CROSS REFERENCE TO RELATED APPLICATIONS

This application claims priority to and the benefit of U.S. Provisional Patent Application No. 61/801,093, filed 15 Mar. 2013, the disclosure of which is now expressly incorporated herein by reference.

### GOVERNMENT RIGHTS

The present application was made with United States government support under Contract No. F33615-03-D-2357 awarded by the Department of Defense. The United States government may have certain rights in the present application.

### TECHNICAL FIELD

The present disclosure generally relates to titanium aluminide components. More particularly, but not exclusively, the present disclosure relates to multiphase titanium aluminide structural components.

### BACKGROUND

Present approaches to titanium aluminide structural components suffer from a variety of drawbacks, limitations, disadvantages and problems including those respecting manufacturability and others. There is a need for the unique and inventive titanium aluminide structural component apparatuses, systems and methods disclosed herein.

### SUMMARY

One embodiment of the present disclosure is a unique titanium aluminide structural component. Other embodiments include apparatuses, systems, devices, hardware, methods, and combinations for multiphase titanium aluminide structural components. Further embodiments, forms, features, aspects, benefits, and advantages of the present application shall become apparent from the description and figures provided herewith.

Titanium aluminide is an intermetallic material with low ductility and limited heat treatability making the material difficult to fabricate. Poor machining qualities of titanium aluminide include metallurgical surface defects such as chipping and cracking in thin sections, sharp edges, and grain pull out. Low ductility of titanium aluminide limits the compaction quality of a titanium aluminide powder in a powder metal process. Low heat treatability limits the ability to form satisfactory microstructures following mechanical machining.

### BRIEF DESCRIPTION OF THE FIGURES

FIG. 1 is a flow diagram of an embodiment of the present disclosure;

FIG. 2 is a cross-sectional view of a portion of an embodiment of the present disclosure; and

FIG. 3 is a cross-sectional view of a component from an embodiment of the present disclosure.

### DETAILED DESCRIPTION OF THE DRAWINGS

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications in the described embodiments, and any further applications of the principles of the disclosure as described herein are contemplated as would normally occur to one skilled in the art to which the disclosure relates.

An embodiment of the present application includes a powdered metal gamma titanium aluminide (TiAl) inner portion within a skin-structure of titanium forming high temperature gas turbine engine components. Titanium aluminide offers mechanical properties such as high stiffness, high temperature capability and a strength to weight ratio improvement over nickel alloys. A titanium aluminide component can be formed by creating a casing skin structure of titanium, filling the casing skin structure with a gamma titanium aluminide powder and hot isostatically pressing the structure of the titanium aluminide component.

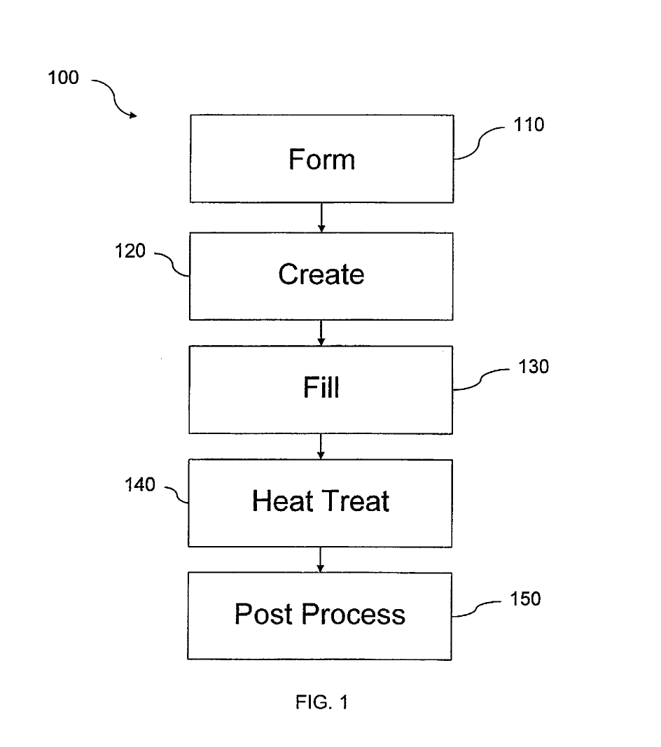

With reference to FIG. 1, a Process 100 is shown representative of an embodiment for manufacturing a titanium-aluminide high temperature gas turbine engine component of the present application. Gas turbine engine components can include a compressor case, vane bands, clearance control rings, and other large/stationary structural parts. Some embodiments apply to components with complex surfaces and features requiring high strength at elevated temperatures where standard titanium materials no longer perform adequately.

Process 100 is shown to begin with a forming Operation 110. Operation 110 forms an outer region of a component as a sheet metal structure. The sheet metal structure can be formed though fabrication techniques such as stamping, shaping, welding, and the like. Multiple sheet metal structures can be formed to produce a component outer region. In other embodiments, a single sheet metal structure can be formed to produce the component outer region.

The sheet metal structure can include a common titanium material such as Ti 6-4, Ti 6-2-4-2, Ti 6-6, IM834 and the like. One such material can be Ti6-4 having a representative composition of Al 6 wt. %, V 4 wt. %, Fe 0.25 wt. % max, 0 0.2 wt. % max, and Ti 90 wt. %. Such titanium materials can be designated as UNS R56400, ASTM Grade 5 titanium, UNS R56401 (ELI), and Ti6AI4V, for example. In another embodiment, the sheet metal structure can include a titanium material such as Ti 6-2-4-2 with a representative composition of Al 6 wt. %, Sn 2 wt. %, Zr 4 wt. %, Mo 2 wt. %, and Ti 86 wt. %. Titanium materials of this embodiment can be designated as USA Aerospace: AMS 4919 and UNS R54620, for example. In further embodiments, silicon can be added to improve creep resistance where the titanium sheet metal material could include Ti-6Al-2Sn-4Zr-2Mo-0.08Si.

In various embodiments, a sheet metal structure formed as the outer region of a component can be a complex shape with variable geometry. In response to the complex component shape, the sheet metal structure can form a complex 3D object. Complex 3D objects can include objects which are not easily specified by simple geometric shapes. A complex 3D object can be considered complex due to shaping, inclusion of physical features, dimensioning, or other indicia of complexity generally understood by one of ordinary skill in the art. For example, a 3D object with one or more curvilinear surfaces that vary in 3D space can be complex. In another example, an object with a design specification naming precise dimensional tolerances can be considered complex. Objects having other features that make manufacturing, service or repair of the object non-routine or non-conventional is contemplated in the present application as a complex object. In certain embodiments, a complex object includes a surface having a plurality of concavities. For example, a blade portion of a gas turbine engine having a first concavity toward the blade base and a second concavity toward the blade tip can be a complex object.

An aspect of various embodiments can include the construction of the sheet metal skins to represent the finished or near-finished cross-section of a structural body. The forming of near-net shape structural skins for a component can reduce metal removal at a final machining step as many features can be placed in the casing skins prior to filling with powder metal. Therefore, the features are not machined-off for component completion.

Process 100 can further include a joining Operation 120 where the portions or sheet metal sections are secured together through welding, brazing, or other joining methods. Operation 120 can include sealing the sheet metal portions to create a preform of near-net shape. As part of the joining Operation 120, fine tolerance machining can be applied to provide a surface with the dimensions of the component. Some of the fine tolerance machining can include modifying a weld or joining line.

A filling Operation 130 of Process 100 includes filling the sheet metal structure formed in Operation 110 and 120 with a gamma titanium aluminide powder. Operation 130 can introduce the powder metal material to the casing skin or structure with various filling techniques which can include vibration and tamping. Factors that can influence preform powder filing characteristics include, but are not limited to, powder flow properties, air escape from the powder and air escape from the sheet metal preform.

A gamma titanium aluminide (TiAl) core of powder metal can provide material properties similar to wrought or cast TiAl components. Gamma TiAl has a very low coefficient of thermal expansion (<½ of Nickel) as well as a low density of 0.150 lbs/cubic inch (half of most super-alloy compounds) which would be well-suited for high temperature gas turbine engine applications. Gamma TiAl is expected to hold tighter tip clearances throughout an extremely wide range of flight conditions therefore improving performance and reducing fuel costs along with other aspects of good tip-clearance control benefits.

Gamma titanium aluminide alloys can include the intermetallic compound TiAl and can include titanium aluminide with alloying additions which enable the alloys to exhibit both sufficient mechanical properties and environmental capabilities for use in high temperature applications associated with gas turbine and automotive engines. Gamma titanium aluminide alloys can have a nominal aluminum content of about 46 wt. %. Gamma titanium aluminide alloys can further include niobium at about 3 to about 5 wt. % and tungsten at about 1 wt. % nominally, so as to selectively enhance the oxidation resistance of the alloy.

Following an embodiment of the present application, a gamma titanium aluminide alloy is provided based on the intermetallic compound TiAl having an aluminum content of about 46 wt. %, such that the resulting alloy is characterized by high strength at elevated temperatures in excess of about 1600° F. In further embodiments, the gamma TiAl alloy can contain a relatively high concentration of niobium and a relatively low concentration of tungsten to selectively enhance the oxidation resistance of the alloy at temperatures up to about 1800° F. In one embodiment, niobium is present in the alloy on the order of about 3 to about 5 wt. %, and tungsten is present on the order of about 0.5 to about 1.5 wt. %. The gamma TiAl of this embodiment can be designated with an approximate composition in atomic percents as Ti-46Al-5Nb-1W.

After filling the sheet metal structure with the powder metal, Operation 130 can include sealing the sheet metal structure with the powder metal to create a near-net shaped preform of the component. Sealing the preform or capsule can include evacuating the sheet metal structure and testing the integrity of the seal. The sheet metal capsule can operate as a non-sacrificial container for the powder metal core producing an integrated multi-phase component. One embodiment can include producing a titanium skin structure with multiple sections joined to hold the gamma titanium aluminide powder before being placed in a container for heat treating. An alternative embodiment can include an incomplete seal for designs or applications where the sheet metal structure is not required to contain the powder metal during processing.

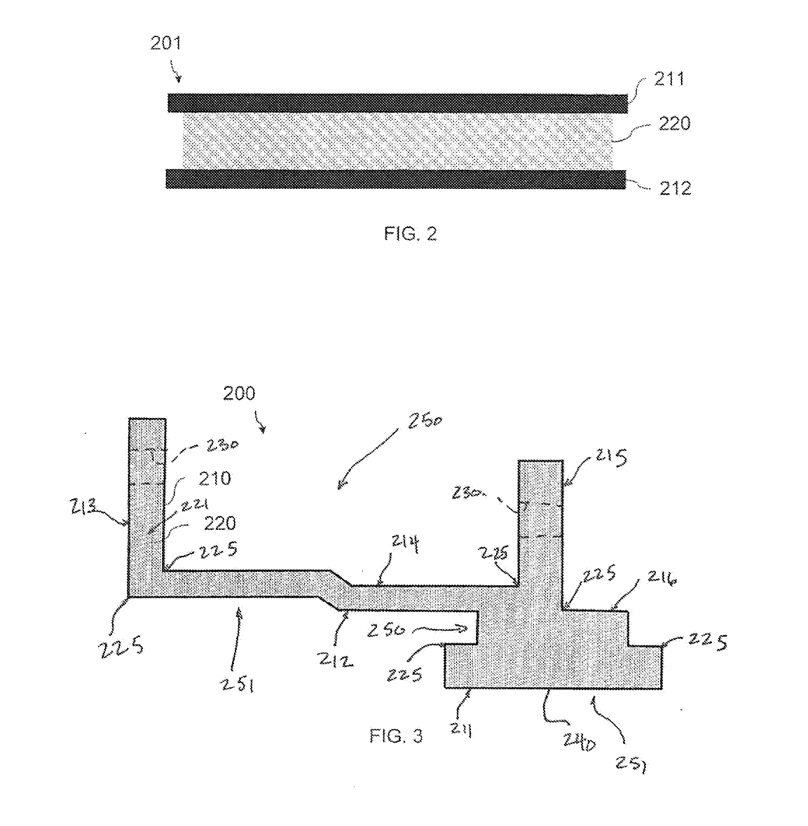

FIG. 2 is a cross-section of a general arrangement of the construction for an embodiment of the present application. A component portion 201 has a sheet metal structure including a first sheet metal portion 211 and a second sheet metal portion 212. Embodiments can include a number of sheet metal portions including a single sheet metal portion to form the sheet metal structure. FIG. 2 also shows a powder metal core portion 220. Further embodiments can have multiple powder metal materials in the powder metal core portion 220.

A heat treating Operation 140 is applied to the powder metal core and the sheet metal structure assembly. Operation 140 sinters the powder metal core portion and integrally bonds the sheet metal structure to the powder metal core portion. In one embodiment, an entire assembly is hot isostatically pressed (HIPed) to sinter the gamma titanium aluminide powder and join it to the titanium shell-structure.

For hot isostatic pressing heat treatment, the assembly of sheet metal skin and powder metal core is subjected to an increase in temperature and pressure. A component with the sheet metal skin and the powder metal core is placed in a vessel and the vessel is pressurized. The gas pressure acts uniformly in all directions to provide isostatic properties. The increased temperature initiates a sintering process and the increased pressure aids in the densification of the powder metal during the sintering process.

After the sheet metal capsule and powder metal core assembly are heat treated, Process 100 can include a post-processing Operation 150. Various post heat treating processes can be applied in Operation 150. Final machining can include drilling holes and polishing tightly dimensioned or controlled surfaces or features with the remaining finishes and surface textures expected to be an improvement over castings. Another post-processing operation can include the removal of a container if one is used in a hot isostatic pressing process.

Embodiments of the present application can include components having relative lower weight, increased structural stiffness, reduced coefficient of thermal expansion, reduced machining complexity, and more efficient use of material among other aspects. Current high-temperature materials used for structural purposes in compressors, combustors, turbines, exhaust nozzles, augmenters, etc. are generally required to be constructed of super-alloy nickel compounds with high densities. The result for using the super-alloy nickel materials is increased weight for an entire engine system along with increased thermal growth stack-up requirements due to their inherent high coefficient of thermal expansions (alpha).

One aspect of components such as compressor cases of the present application is to remain circular at a consistent size under thermal influence as well as resist growth under thermal fluctuations. If a tight tolerance can be manufactured to match rotor blade tips and maintained throughout a flight envelope, then the tight tip clearance will result in improved engine efficiency, surge margin, stability, performance, etc. As mentioned before, the large thermal expansion of current case metals directly influences tip clearance under fluctuating flight envelope conditions.

One embodiment can include a gas turbine engine assembly with two components having a tight tolerance between them. At least one component is formed with a complex shaped sheet metal skin of titanium filled with a powder metal core of titanium aluminide. The complex shaped sheet metal skin and powder metal core are integrated during a hot isostatic pressing process. With a component having an integrated titanium skin and titanium aluminide powder core as found in the present application, the tolerance between the two components is limited during operating conditions such as high temperatures. Further, the sheet metal skin can be composed of multiple portions joined together to form the complex shape where the cross section of the complex component has variable geometry.

Generally, nickel alloys have a higher stiffness than standard titanium alloys and are therefore selected for these applications. Titanium aluminides have nearly the same modulus as comparable nickel alloys but at half the weight per volume of material. In response to this characteristic for titanium aluminide, designs are capable of allowing a change in materials from nickel to gamma titanium aluminide without having to increase thickness and geometry to achieve the same stiffness for a given component as can be required for standard titanium alloys.

The design for a gamma titanium aluminide structure of an embodiment including a ring casing is shown in FIG. 3. An outer region of titanium sheet metal 210 is formed to create a capsule of the component structure which is filled with gamma titanium aluminide powdered metal 220. The entire assembly 200 is then hot-isostatically pressed to produce a single integrated solid structure. FIG. 3 illustrates a cross-section of the component structure of this embodiment showing a structural component with a complex geometry. The high temperature mechanical properties of the integrated gamma titanium aluminide can be applied with the variable geometry of the ring casing in this example.

According to an aspect of the present disclosure, a case 200 (or other component) for use in a gas turbine engine may include a sheet metal skin 210 and a core 220. The sheet metal skin 210 may be made from a first material including titanium. The sheet metal skin may be formed to define a plurality of cross-sectional concave features 250, circumferential concave features 251, and to define an internal cavity 221. The core 220 may be made from a second material including titatium and aluminum arranged in the internal cavity 221 and may be integrally bonded to the sheet metal skin 210 to reinforce the sheet metal skin 210.

In some embodiments, the sheet metal skin 210 may include a plurality of sheet metal portions 211-216 having edges arranged adjacent to one another to form joints 225. The sheet metal skin 210 may sealed along joints 225. The joints 225 may be sealed may be weld lines that seals the joints 225.

In some embodiments, the second material is a gamma titanium-aluminide alloy. The gamma titanium-aluminide alloy may have an aluminum content of about 46 percent by weight.

In some embodiments, the case 200 may be manufactured by a process including the steps of filling the internal cavity of the sheet metal skin with a powder metal material, sealing the internal cavity of the sheet metal skin with the powder metal material inside to form a near-net shaped preform, and heating the near-net shaped preform to a predetermined temperature at which the powder metal material is sintered to provide the core. In some embodiments, the heating step may be performed in a pressurized atmosphere.

In some embodiments, the process may include a step of drilling holes 230 into the component to form post-processed features. In some embodiments, the process may include a step of polishing external surfaces of the component to provide controlled surfaces 240.

According to another aspect of the present disclosure, a method may comprise the steps of forming a first portion and a second portion of a titanium alloy sheet metal structure, partially joining the first portion and the second portion of the titanium alloy sheet metal structure, filing the titanium alloy sheet metal structure with a gamma titanium aluminide powder metal, creating a near-net shape perform by sealing the titanium alloy sheet metal structure, and hot isostatic pressing the near-net shape perform to integrally bond the titanium alloy sheet metal structure with the gamma titanium aluminide powder metal.

In some embodiments, the method may include the step of drilling holes 230 into the component to form post-processed features. In some embodiments, the method may include the step of polishing external surfaces of the component to provide controlled surfaces 240.

While the invention has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A case for use in a gas turbine engine comprising a sheet metal skin made from a first material including titanium, the sheet metal skin formed to define a plurality of concave features and to define an internal cavity, and a core made from a second material including titatium and aluminum arranged in the internal cavity and integrally bonded to the sheet metal skin to reinforce the sheet metal skin.

2. The case of claim 1, wherein the sheet metal skin includes a first sheet metal portion having a first edge and a second sheet metal portion having a second edge arranged adjacent to the first edge to form a joint therebetween.

3. The case of claim 2, wherein joint is sealed by a weld line.

4. The case of claim 1, wherein the second material is a gamma titanium-aluminide alloy.

5. The case of claim 4, wherein the gamma titanium-aluminide alloy has an aluminum content of about 46 percent by weight.

6. A component for use in a gas turbine engine comprising
a sheet metal skin made from a first material including titanium, the sheet metal skin formed to define a plurality of concave features and to define an internal cavity, and
a core made from a second material including titatium and aluminum arranged in the internal cavity and integrally bonded to the sheet metal skin to reinforce the sheet metal structure.

7. The component of claim 6, wherein the sheet metal skin includes a first sheet metal portion having a first edge and a second sheet metal portion having a second edge arranged adjacent to the first edge to form a joint therebetween.

8. The component of claim 7, wherein joint is sealed by a weld line.

9. The component of claim 6, wherein the second material is a gamma titanium-aluminide alloy.

10. The component of claim 9, wherein the gamma titanium-aluminide alloy has an aluminum content of about 46 percent by weight.

11. The component of claim 6, wherein the component is manufactured by a process including the steps of (i) filling the internal cavity of the sheet metal skin with a powder metal material, (ii) sealing the internal cavity of the sheet metal skin with the powder metal material inside to form a near-net shaped preform, and (iii) heating the near-net shaped preform to a predetermined temperature at which the powder metal material is sintered to provide the core.

12. The component of claim 11, wherein the heating step is performed in a pressurized atmosphere.

13. The component of claim 11, wherein the process further includes the step of (iv) drilling holes into the component to form post-processed features.

14. The component of claim 11, wherein the process further includes the step of (iv) polishing external surfaces of the component to provide controlled surfaces.

15. A method comprising the steps of
forming a first portion and a second portion of a titanium alloy sheet metal structure,
partially joining the first portion and the second portion of the titanium alloy sheet metal structure,
filing the titanium alloy sheet metal structure with a gamma titanium aluminide powder metal,
creating a near-net shape perform by sealing the titanium alloy sheet metal structure, and
hot isostatic pressing the near-net shape perform to integrally bond the titanium alloy sheet metal structure with the gamma titanium aluminide powder metal.

16. The component of claim 15, wherein the method further includes the step of drilling holes into the component to form post-processed features.

17. The component of claim 15, wherein the method further includes the step of polishing external surfaces of the component to provide controlled surfaces.

18. The component of claim 15, wherein the gamma titanium-aluminide powder has an aluminum content of about 46 percent by weight.
